(19) United States
(12) Patent Application Publication
(10) Pub. No.: US 2026/0057639 A1
(43) Pub. Date: Feb. 26, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Takashi SHIBATA, Tokyo (JP); Shuhei YOSHIDA, Tokyo (JP); Yuki TANAKA, Tokyo (JP); Makoto TERAO, Tokyo (JP); Takuya OGAWA, Tokyo (JP); Masahiro YAMAGUCHI, Tokyo (JP); Toshinori HOSOI, Tokyo (JP); Hiroyoshi MIYANO, Tokyo (JP); Yasunori BABAZAKI, Tokyo (JP); Toru TAKAHASHI, Tokyo (JP); Ryuhei ANDO, Tokyo (JP)

(73) Assignee: NEC Corporation, Tokyo (JP)

(21) Appl. No.: 19/289,499

(22) Filed: Aug. 4, 2025

(30) Foreign Application Priority Data
Aug. 22, 2024 (JP) 2024-141088

(51) Int. Cl. G06V 10/40

(52) U.S. Cl. CPC G06V 10/40

(57) ABSTRACT

An information processing device includes a memory configured to store instructions; and one or more processors configured to execute the instructions to: predict a trajectory of an object included in at least one of a plurality of target images with reference to a plurality of target images; extract a feature of the trajectory and calculate a reliability of the trajectory based on the feature; generate a virtual label in which each of the plurality of target images, a position of the object included in the target image, the trajectory, and the reliability are associated with each other; and learn a state transition model that predicts a state of an object included in a plurality of images by using the virtual label.

This application is based upon and claims the benefit of priority from Japanese Patent Application No. 2024-141088, filed on Aug. 22, 2024, the disclosure of which is incorporated herein in its entirety by reference.

### TECHNICAL FIELD

The present disclosure relates to an information processing device, an information processing method, and a recording medium.

### BACKGROUND ART

A technique for predicting a trajectory of a moving object using a machine learning model is disclosed. For example, JP 2024-509344 A discloses a method of processing an observation trajectory by a machine learning technique to generate a plurality of prediction trajectories.

### SUMMARY

The present disclosure provides a technique or the like for compensating for a shortage of training data for learning a machine learning model for predicting a trajectory of an object.

An information processing device according to an exemplary aspect of the present disclosure includes: a trajectory prediction means for predicting a trajectory of an object included in at least one of a plurality of target images with reference to a plurality of target images; a calculation means for extracting a feature of the trajectory and calculating a reliability of the trajectory based on the feature; a virtual label generation means for generating a virtual label in which each of the plurality of target images, a position of the object included in the target image, the trajectory, and the reliability are associated with each other; and a learning means for learning a state transition model that predicts a state of an object included in a plurality of images by using the virtual label.

An information processing method according to an exemplary aspect of the present disclosure causes at least one processor to execute: a process of predicting a trajectory of an object included in at least one of a plurality of target images with reference to a plurality of target images; a process of extracting a feature of the trajectory and calculating a reliability of the trajectory based on the feature; a process of generating a virtual label in which each of the plurality of target images, a position of the object included in the target image, the trajectory, and the reliability are associated with each other; and a process of learning a state transition model that predicts a state of an object included in a plurality of images by using the virtual label.

An information processing program according to an exemplary aspect of the present disclosure is a program for causing a computer to function as an information processing device including: a trajectory prediction means for predicting a trajectory of an object included in at least one of a plurality of target images with reference to a plurality of target images; a calculation means for extracting a feature of the trajectory and calculating a reliability of the trajectory based on the feature; a virtual label generation means for generating a virtual label in which each of the plurality of target images, a position of the object included in the target image, the trajectory, and the reliability are associated with each other; and a learning means for learning a state transition model that predicts a state of an object included in a plurality of images by using the virtual label.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an information processing device according to the present disclosure;

FIG. 2 is a flowchart illustrating a flow of an information processing method according to the present disclosure;

FIG. 3 is a diagram illustrating an example of an outline of processing in which the information processing device according to the present disclosure generates training data;

FIG. 4 is a block diagram illustrating a configuration of the information processing device according to the present disclosure;

FIG. 5 is a flowchart illustrating a flow of an information processing method according to the present disclosure; and

FIG. 6 is a block diagram illustrating a configuration of a computer functioning as the information processing device according to the present disclosure.

### EXAMPLE EMBODIMENT

Hereinafter, example embodiments of the present disclosure will be described. However, the present disclosure is not limited to the example embodiments described below, and various modifications can be made within the scope described in the claims. For example, example embodiments obtained by appropriately combining technical means adopted in the following example embodiments can also be included in the scope of the present disclosure. Example embodiments obtained by appropriately omitting some of the technical means adopted in the following example embodiments can also be included in the scope of the present disclosure. Effects mentioned in the following example embodiments are examples of effects expected in the example embodiments, and do not define the extension of the present disclosure. That is, example embodiments that do not achieve the advantages mentioned in the following example embodiments can also be included in the scope of the present disclosure.

### First Example Embodiment

A first example embodiment, which is an example of an example embodiment of the present disclosure, will be described in detail with reference to the drawings. The present example embodiment is a basic form of each example embodiment described below. An application range of each technique adopted in the present example embodiment is not limited to the present example embodiment. That is, each technical means adopted in the present example embodiment can also be adopted in other example embodiments included in the present disclosure as long as no particular technical problem occurs. Each technical means illustrated in the drawings referred to for describing the present example embodiment can also be adopted in other example embodiments included in the present disclosure as long as no particular technical problem occurs.

### Configuration of Information Processing Device 1

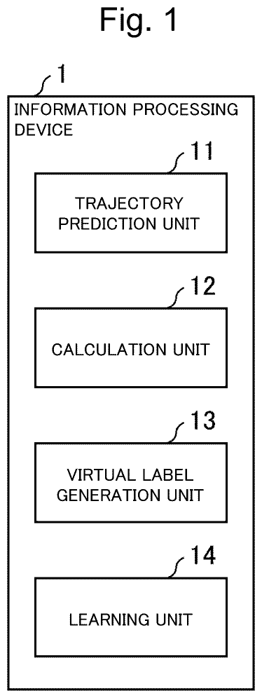

A configuration of an information processing device 1 will be described with reference to FIG. 1. FIG. 1 is a block diagram illustrating a configuration of the information processing device 1. As illustrated in FIG. 1, the information processing device 1 includes a trajectory prediction unit 11, a calculation unit 12, a virtual label generation unit 13, and a learning unit 14. The trajectory prediction unit 11, the calculation unit 12, the virtual label generation unit 13, and the learning unit 14 implement a trajectory prediction means, a calculation means, a virtual label generation means, and a learning means, in the present example embodiment.

### Trajectory Prediction Unit 11

The trajectory prediction unit 11 predicts a trajectory of an object included in at least one of a plurality of target images with reference to the plurality of target images. The trajectory prediction unit 11 supplies information indicating the predicted trajectory to the calculation unit 12 and the virtual label generation unit 13.

### Calculation Unit 12

The calculation unit 12 extracts a feature of the trajectory predicted by the trajectory prediction unit 11, and calculates a reliability of the trajectory based on the feature. The calculation unit 12 supplies the calculated reliability to the virtual label generation unit 13.

### Virtual Label Generation Unit 13

The virtual label generation unit 13 generates a virtual label in which each of the plurality of target images, a position of the object included in the target image, the trajectory predicted by the trajectory prediction unit 11, and the reliability calculated by the calculation unit 12 are associated with each other. The virtual label generation unit 13 supplies the generated virtual label to the learning unit 14.

### Learning Unit 14

The learning unit 14 learns a state transition model for predicting a state of the object included in the plurality of images using the virtual label generated by the virtual label generation unit 13.

### Effects of Information Processing Device 2

As described above, the information processing device 2 employs a configuration including the trajectory prediction unit 11 that predicts a trajectory of an object included in at least one of a plurality of target images with reference to the plurality of target images, the calculation unit 12 that extracts a feature of the trajectory predicted by the trajectory prediction unit 11 and calculates a reliability of the trajectory based on the feature, the virtual label generation unit 13 that generates a virtual label in which each of the plurality of target images, a position of the object included in the target image, the trajectory predicted by the trajectory prediction unit 11, and the reliability calculated by the calculation unit 12 are associated with one another, and the learning unit 14 that learns a state transition model for predicting a state of the object included in the plurality of images using the virtual label generated by the virtual label generation unit 13.

Therefore, according to the information processing device 2, since the virtual label for learning the state transition model is generated, it is possible to compensate for the shortage of the training data for learning the machine learning model for predicting the trajectory of the object.

### Flow of Information Processing Method S1

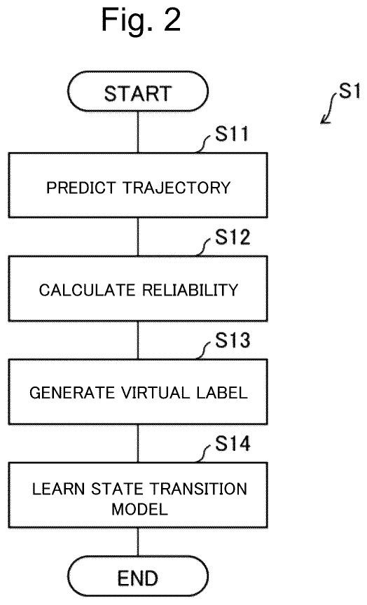

A flow of an information processing method SI will be described with reference to FIG. 2. FIG. 2 is a flowchart illustrating the flow of the information processing method S1. As illustrated in FIG. 2, the information processing method S1 includes trajectory prediction processing S11, calculation processing S12, virtual label generation processing S13, and learning processing S14.

### Trajectory Prediction Processing S11

In the trajectory prediction processing S11, the trajectory prediction unit 11 predicts a trajectory of an object included in at least one of a plurality of target images with reference to the plurality of target images. The trajectory prediction unit 11 supplies information indicating the predicted trajectory to the calculation unit 12 and the virtual label generation unit 13.

### Calculation Processing S12

In the calculation processing S12, the calculation unit 12 extracts a feature of the trajectory predicted by the trajectory prediction unit 11, and calculates a reliability of the trajectory based on the feature. The calculation unit 12 supplies the calculated reliability to the virtual label generation unit 13.

### Virtual Label Generation Processing S13

In the virtual label generation processing S13, the virtual label generation unit 13 generates a virtual label in which each of the plurality of target images, a position of the object included in the target image, the trajectory predicted by the trajectory prediction unit 11, and the reliability calculated by the calculation unit 12 are associated with each other. The virtual label generation unit 13 supplies the generated virtual label to the learning unit 14.

### Learning Processing S14

In the learning processing S14, the learning unit 14 learns a state transition model for predicting a state of the object included in the plurality of images using the virtual label generated by the virtual label generation unit 13.

### Effect of Information Processing Method S1

As described above, in the information processing method S1, the trajectory prediction unit 11 employs a configuration including the trajectory prediction processing S11 of predicting, by the trajectory prediction unit 11, a trajectory of an object included in at least one of a plurality of target images with reference to the plurality of target images, the calculation processing S12 of extracting, by the calculation unit 12, a feature of a trajectory predicted by the trajectory prediction unit 11 and calculating a reliability of the trajectory based on the feature, the virtual label generation processing S13 of generating, by the virtual label generation unit 13, a virtual label in which each of the plurality of target images, a position of an object included in the target image, the trajectory predicted by the trajectory prediction unit 11, and the reliability calculated by the calculation unit 12 are associated with each other, and the learning processing S14 of learning, by the learning unit 14, a state transition model for predicting a state of an object included in a plurality of images using a virtual label generated by the virtual label generation unit 13.

Therefore, according to the information processing method S1, effects similar to those of the information processing device 1 described above can be obtained.

### Second Example Embodiment

A second example embodiment, which is an example of an example embodiment of the present disclosure, will be described in detail with reference to the drawings. Components having the same functions as the components described in the above-described example embodiment will be denoted by the same reference numerals, and the description thereof will be appropriately omitted. An application range of each technique adopted in the present example embodiment is not limited to the present example embodiment. That is, each technical means adopted in the present example embodiment can also be adopted in other example embodiments included in the present disclosure as long as no particular technical problem occurs. Each technique illustrated in each of the drawings referred to for describing the present example embodiment can be employed in the other example embodiments included in the present disclosure within a range in which no particular technical problem occurs.

### Outline of Information Processing Device 2

The information processing device 2 is a device that generates training data for learning a machine learning model. As an example, the information processing device 2 generates training data for learning a state transition model for predicting a state of an object included in an image. An example of the state transition model is a prediction model that receives a plurality of images as inputs, detects an object included in the image, and predicts a trajectory of the detected object. As an example, the prediction model may include an object detection model that detects an object included in an image and a trajectory prediction model that predicts a trajectory of the object detected by the object detection model.

The information processing device 2 causes the state transition model for predicting the state of the object included in the image to be learned using the generated training data. The information processing device 2 may learn a state transition model used for generating the training data, or may perform knowledge distillation of a state transition model lighter than the state transition model used for generating the training data.

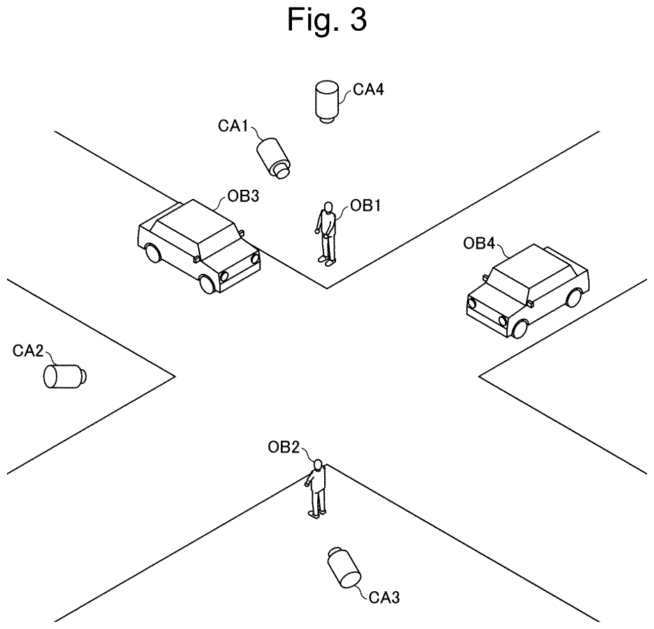

An example of an outline of processing in which the information processing device 2 generates training data will be described with reference to FIG. 3. FIG. 3 is a diagram illustrating an example of an outline of processing in which the information processing device 2 generates training data.

FIG. 3 illustrates a state in which a plurality of cameras CA1 to CA4 capture an image of an intersection. The information processing device 2 acquires a target image captured by each of the plurality of cameras CA1 to CA4, and predicts a trajectory of an object included in the target image. For example, in a case where a person OB2 and a car OB3 are included as objects in the target image captured by the camera CA1, the information processing device 2 predicts the trajectory of the person OB2 and the trajectory of the car OB3.

The information processing device 2 calculates a reliability of the predicted trajectory, and generates a virtual label including the reliability as training data. The information processing device 2 learns the state transition model using the virtual label.

As an example, as illustrated in FIG. 3, the cameras CA1 to CA4 may include a camera CA4 that captures an object from above. With this configuration, since the information processing device 2 can acquire the target image obtained by capturing the entire motion of the object, the target image can be used as a reference of the target image captured by the other cameras CA1 to CA3.

### Configuration of Information Processing Device 2

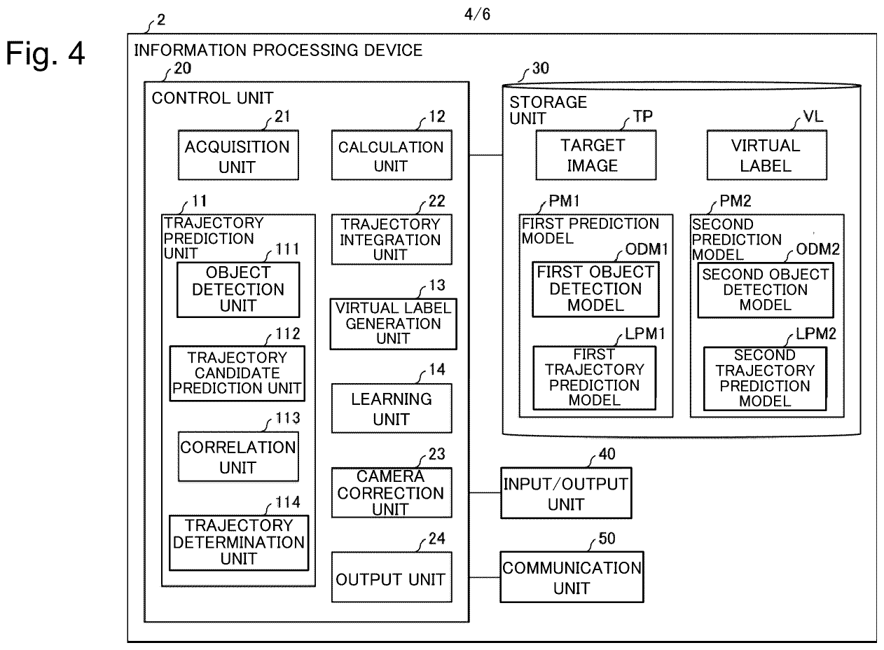

The configuration of the information processing device 2 will be described with reference to FIG. 4. FIG. 4 is a block diagram illustrating the configuration of the information processing device 2. As illustrated in FIG. 4, the information processing device 2 includes a control unit 20, a storage unit 30, an input/output unit 40, and a communication unit 50.

### Storage Unit 30

The storage unit 30 stores data to be referred to by the control unit 20. Examples of the storage unit 30 include, but are not limited to, a flash memory, a hard disk drive (HDD), a solid state drive (SSD), or a combination thereof.

Examples of the data stored in the storage unit 30 include, but are not limited to, a target image TP, a virtual label VL, a first prediction model PM1, and a second prediction model PM2.

Each of the first prediction model PM1 and the second prediction model PM2 is a state transition model that predicts a state of an object included in a plurality of images. The second prediction model PM2 is a state transition model that is lighter than the first prediction model PM1.

More specifically, each of the first prediction model PM1 and the second prediction model PM2 is a machine learning model learned to predict a trajectory of an object included in a plurality of images as an input.

The first prediction model PM1 includes a first object detection model ODM1 and a first trajectory prediction model LPM1. The second prediction model PM2 includes a second object detection model ODM2 and a second trajectory prediction model LPM2.

Each of the first object detection model ODM1 and the second object detection model ODM2 is a machine learning model learned to detect an object included in an image using the image as an input.

The first trajectory prediction model LPM1 is a machine learning model learned to predict one or a plurality of trajectory candidates of the object detected by the first object detection model ODM1. The second trajectory prediction model LPM2 is a machine learning model learned to predict one or a plurality of trajectory candidates of the object detected by the second object detection model ODM2.

### Input/Output Unit 40

The input/output unit 40 is an interface with an input device that receives an input of data and an output device that outputs data. Examples of the input device include, but are not limited to, a microphone, a camera, a line-of-sight input device, a keyboard, and a touch pad. Examples of the output device include, but are not limited to, a speaker and a liquid crystal display.

### Communication Unit 50

The communication unit 50 is an interface for transmitting and receiving data via a network. Examples of the communication unit 50 include, but are not limited to, a communication chip in various communication standards such as Ethernet (registered trademark), Wi-Fi (registered trademark), and wireless communication standards of mobile data communication networks, and connectors compliant with USB.

The specific configuration of the network is not particularly limited, but as an example, a wireless local area network (LAN), a wired LAN, a wide area network (WAN), a public line network, a mobile data communication network, or a combination of these networks can be used.

### Control Unit 20

The control unit 20 controls each component included in the information processing device 2. As illustrated in FIG. 4, the control unit 20 includes an acquisition unit 21, a trajectory prediction unit 11, a calculation unit 12, a trajectory integration unit 22, a virtual label generation unit 13, a learning unit 14, a camera calibration unit 23, and an output unit 24. The acquisition unit 21, the trajectory prediction unit 11, the calculation unit 12, the trajectory integration unit 22, the virtual label generation unit 13, the learning unit 14, the camera calibration unit 23, and the output unit 24 implement an acquisition means, a trajectory prediction means, a calculation means, a trajectory integration means, a virtual label generation means, a learning means, a camera calibration means, and an output means, in the present example embodiment.

### Acquisition Unit 21

The acquisition unit 21 acquires data supplied from the input/output unit 40 or the communication unit 50. The acquisition unit 21 stores the acquired data in the storage unit 30.

As an example, the acquisition unit 21 acquires a plurality of target images TP. For example, in FIG. 3 described above, a plurality of images captured by the camera CA1 for a predetermined period is acquired as a plurality of target images TP. Hereinafter, a plurality of images captured by a certain camera CA for a predetermined period is also referred to as a moving image.

The acquisition unit 21 similarly acquires the moving images captured by the cameras CA2 to CA4 as the plurality of target images TP for the cameras CA2 to CA4. Hereinafter, in a plurality of images (moving images), a certain image at a certain time is also referred to as a “frame”, an image temporally before the certain image is also referred to as a “previous frame”, and an image temporally after the certain image is also referred to as a “subsequent frame”. As another example, the acquisition unit 21 acquires an instruction for the user interface output by the output unit 24 described later.

### Trajectory Prediction Unit 11

The trajectory prediction unit 11 predicts a trajectory of an object included in an image. The trajectory prediction unit 11 supplies trajectory information indicating the predicted one or a plurality of trajectories to the calculation unit 12 and the trajectory integration unit 22.

As an example, the trajectory prediction unit 11 predicts the trajectory of the object included in at least one of the plurality of target images TP with reference to the plurality of target images TP. For example, in FIG. 3 described above, the trajectory prediction unit 11 predicts the trajectory of the object (person OB1, person OB2, car OB3, and car OB4) included in at least one of the plurality of target images TP with reference to the plurality of target images TP (moving images) captured by the cameras CA1 to CA4 for a predetermined period.

For example, when the person OB2 and the car OB3 are included in a moving image 1 captured by the camera CA1 from time t-n (n is 2 or more) to time t-1, the trajectory prediction unit 11 predicts a trajectory of the person OB2 and a trajectory of the car OB3 after time t with reference to the moving image 1.

Similarly, when the person OB1 and the car OB3 are included in a moving image 2 captured by the camera CA2 from time t-n to time t-1, the trajectory prediction unit 11 predicts a trajectory of the person OB1 and the trajectory of the car OB3 after time t with reference to the moving image 2.

The trajectory prediction unit 11 predicts the trajectory of the object included in at least one of the plurality of target images TP by inputting the plurality of target images TP to the first prediction model PM1 that predicts the trajectory of the object included in the image using a plurality of images as inputs. With this configuration, the trajectory prediction unit 11 can suitably predict the trajectory of the object included in the target image TP.

As illustrated in FIG. 4, the trajectory prediction unit 11 includes an object detection unit 111, a trajectory candidate prediction unit 112, a correlation unit 113, and a trajectory determination unit 114.

The object detection unit 111 detects an object included in the image. As an example, the object detection unit 111 detects the object included in the target image TP by inputting the target image TP to the first object detection model ODM1 of the first prediction model PM1. The object detection unit 111 supplies information indicating the detected object to the trajectory candidate prediction unit 112. As an example, the object detection unit 111 supplies an image in which an object included in the target image TP is surrounded by a rectangle to the trajectory candidate prediction unit 112 as information indicating the detected object.

The trajectory candidate prediction unit 112 predicts one or a plurality of trajectory candidates of the object included in the image. The trajectory candidate prediction unit 112 supplies the predicted one or a plurality of trajectory candidates to the correlation unit 113. As an example, the trajectory candidate prediction unit 112 inputs, to the first trajectory prediction model LPM1 of the first prediction model PM1, a plurality of target images TP (moving images) captured from time t-n to time t-1 and information indicating the object detected by the object detection unit 111 for each of the plurality of target images TP, thereby predicting one or a plurality of trajectory candidates of the object detected by the object detection unit 111 after time t.

The correlation unit 113 calculates the degree of correlation between the detected position of the object and the position of the object in one or a plurality of trajectory candidates. The correlation unit 113 supplies the calculated degree of correlation to the trajectory determination unit 114. As an example, the correlation unit 113 calculates, as a degree of correlation, a difference between a rectangle surrounding the object OB detected by the object detection unit 111 and included in the target image TP captured at time t and the position of the object OB at time t based on one or a plurality of trajectory candidates of the object OB predicted by the trajectory candidate prediction unit 112 from the moving image captured from time t-n to time t-1.

The trajectory determination unit 114 determines one or a plurality of trajectories of the object included in the image. The trajectory determination unit 114 supplies trajectory information indicating the determined one or a plurality of trajectories to the calculation unit 12 and the trajectory integration unit 22. For example, the trajectory determination unit 114 determines one or a plurality of trajectories in which the degree of correlation calculated by the correlation unit 113 is equal to or greater than a threshold as one or a plurality of trajectories of the object included in the image.

### Calculation Unit 12

The calculation unit 12 extracts a feature of the trajectory and calculates a reliability of the trajectory based on the extracted feature.

As an example, the calculation unit 12 extracts a feature of each of the one or a plurality of trajectories predicted by the trajectory prediction unit 11, and calculates a reliability of each of the one or a plurality of trajectories based on the feature. The calculation unit 12 supplies the extracted feature and the calculated reliability to the trajectory integration unit 22 and the virtual label generation unit 13.

As an example, the calculation unit 12 refers to the trajectory information supplied from the trajectory prediction unit 11 in each frame, calculates at least one of the following indexes for each of one or a plurality of trajectories indicated by the trajectory information, and extracts the calculated index as the feature.

Similarity to a rectangle of an object detected in temporally preceding and subsequent frames

Similarity of a state variable with the motion of a trajectory (for example, speed, acceleration, and the like) as a state variable

Similarity of appearance around the rectangle of the object detected in temporally preceding and subsequent frames

The calculation unit 12 calculates a reliability of the trajectory based on the similarity in the time direction of the features that are the extracted time-series data. For example, the calculation unit 12 sets the higher reliability as the trajectory has a higher similarity of the feature in the time direction.

### Trajectory Integration Unit 22

The trajectory integration unit 22 integrates a plurality of trajectories. The trajectory integration unit 22 supplies the integrated trajectory to the virtual label generation unit 13. As an example, the trajectory integration unit 22 integrates trajectories having similar features and high reliabilities among one or a plurality of trajectories.

For example, it is assumed that the trajectory integration unit 22 integrates the trajectory of the object OB predicted based on the moving image 1 captured by the camera CA1 and the trajectory of the object OB predicted based on the moving image 2 captured by the camera CA2. In the moving image 1 captured by the camera CA1, even if there is a portion where the object OB is hidden behind another object and the trajectory is interrupted or noise is generated, in a case where the trajectory of the portion can be predicted in the moving image 2 captured by the camera CA2, the trajectory integration unit 22 can generate a continuous trajectory of the object OB.

The trajectory integration unit 22 may acquire information detected by a sensor and information relating to the object, and integrate the trajectories by furthers referring to the information. For example, the trajectory integration unit 22 acquires information indicating the position of an object detected by a sensor that detects the position of the object and detected by the object detection unit 111. Then, the trajectory integration unit 22 calculates similarity between the position indicated by the information acquired from the sensor and the position of the object indicated by the trajectory information indicating one or a plurality of trajectories supplied from the trajectory prediction unit 11. When there is a plurality of trajectories having the calculated similarity equal to or greater than a predetermined value, the trajectory integration unit 22 integrates the plurality of trajectories. With this configuration, the trajectory integration unit 22 can integrate the same trajectories with high accuracy among the plurality of trajectories predicted by the trajectory prediction unit 11.

The trajectory integration unit 22 integrates the trajectories based on the instruction to the user interface acquired by the acquisition unit 21. An example of the configuration will be described later.

### Virtual Label Generation Unit 13

The virtual label generation unit 13 generates a virtual label VL for learning the state transition model, in which each of the plurality of target images TP, the position of the object included in the target image TP detected by the object detection unit 111, the trajectory integrated by the trajectory integration unit 22, and the reliability calculated by the calculation unit 12 are associated with each other. The virtual label generation unit 13 stores the generated virtual label VL in the storage unit 30.

The virtual label generation unit 13 generates the virtual label VL based on the instruction for the user interface acquired by the acquisition unit 21. An example of the configuration will be described later.

### Learning Unit 14

The learning unit 14 learns the state transition model. As an example, the learning unit 14 learns at least one of the first prediction model PM1 and the second prediction model PM2 lighter than the first prediction model PM1 using the virtual label VL.

The learning method of the learning unit 14 is not particularly limited, but as an example, the learning unit 14 learns the state transition model using a neural network. As another example, the learning unit 14 models a linear or non-linear state update equation conditional on the trajectory feature (position of object, speed of object, etc.) or an external variable (weather, temperature, etc.), calculates a parameter of the update equation from the accumulated past data by regression, and learns the state transition model.

The higher the reliability associated with the virtual label VL, the more the learning unit 14 adopts the virtual label VL as important training data. More specifically, the learning unit 14 increases the weight of the loss function at the time of learning as the reliability associated with the virtual label VL is higher. With this configuration, the learning unit 14 can learn the state transition model according to the reliability.

### Camera Calibration Unit 23

The camera calibration unit 23 calibrates the postures and the camera parameters of the plurality of cameras using the virtual label VL.

When the plurality of target images TP are images captured by a plurality of cameras that capture an object included in the plurality of target images TP from different positions, the positions of the object are different for each camera. Therefore, in order to align the position of the object for each camera, the camera calibration unit 23 transforms each of the plurality of target images TP captured by each camera into a three-dimensional coordinate system (world coordinate system).

Here, as described above, in a case where the plurality of cameras include a camera that captures an object from above, the camera calibration unit 23 may use an image captured by the camera that captures an object from above as a reference.

The camera calibration unit 23 calibrates the postures and the camera parameters of the plurality of cameras from the trajectory included in the virtual label and the feature and the reliability associated with the trajectory such that the positions of the object included in the plurality of target images TP captured by the cameras match in the three-dimensional coordinate system.

As an example, as illustrated in FIG. 3, it is assumed that a person and a car are moving on the ground. In this case, the camera calibration unit 23 sets a plane parallel to the ground, and calibrates the postures of the plurality of cameras and the camera parameters so as to minimize an error between the trajectories projected in the plane.

The camera calibration unit 23 corrects the plurality of target images TP using the calculated postures of the cameras and camera parameters so that the positions of the object included in the plurality of target images TP coincide with each other in the world coordinate system and time is synchronized.

With this configuration, the camera calibration unit 23 can temporally and spatially synchronize the images captured by the plurality of cameras.

### Output Unit 24

The output unit 24 outputs data to the input/output unit 40 or the communication unit 50. As an example, the output unit 24 outputs a user interface for accepting an instruction for the virtual label VL.

For example, the output unit 24 outputs a user interface which includes an image including the target image TP associated with the virtual label VL, the position of the object included in the target image TP, the trajectory, and the reliability, and accepts an instruction indicating whether the information included in the image is correct. When the user inputs an instruction indicating correctness to the user interface, the acquisition unit 21 acquires an instruction indicating that the information associated with the virtual label VL is correct.

In a case where the acquisition unit 21 acquires an incorrect instruction input by the user to the user interface, the output unit 24 outputs the user interface for accepting an instruction to change at least one of the position, the trajectory, and the reliability of the object included in the target image TP. For example, in a case where the user inputs an instruction to change the position of the object to the user interface, the acquisition unit 21 acquires an instruction to change the position of the object associated with the virtual label VL.

The virtual label generation unit 13 changes the virtual label VL based on the user's instruction acquired by the acquisition unit 21. For example, when the acquisition unit 21 acquires an instruction to change the position of the object associated with the virtual label VL, the virtual label generation unit 13 changes the position of the object associated with the virtual label VL stored in the storage unit 30 to the position indicated by the instruction acquired by the acquisition unit 21.

With this configuration, the virtual label generation unit 13 can generate the virtual label VL with a higher reliability.

As another example, the output unit 24 outputs a user interface for accepting an instruction for one or a plurality of trajectories supplied from the trajectory prediction unit 11.

For example, the output unit 24 outputs a user interface which includes the target image TP including one or a plurality of trajectories supplied from the trajectory prediction unit 11, and is used to accept an instruction as to which trajectory among the one or a plurality of trajectories is the same trajectory. When the user inputs an instruction indicating that a trajectory 1 and a trajectory 2 are the same trajectory to the user interface, the acquisition unit 21 acquires the instruction indicating that the trajectory 1 and the trajectory 2 are the same trajectory.

The trajectory integration unit 22 integrates the trajectories based on the user's instruction acquired by the acquisition unit 21. For example, when the acquisition unit 21 acquires an instruction indicating that the trajectory 1 and the trajectory 2 are the same trajectories, the trajectory integration unit 22 integrates the trajectory 1 and the trajectory 2.

As another example, the output unit 24 outputs a user interface for accepting an instruction as to whether the trajectory to be integrated by the trajectory integration unit 22 is correct. In a case where the user inputs an instruction indicating that the trajectories are correct to the user interface, the acquisition unit 21 acquires an instruction indicating that the trajectories to be integrated by the trajectory integration unit 22 are correct. In this case, the trajectory integration unit 22 integrates the trajectories to be integrated.

On the other hand, in a case where the user inputs an instruction indicating that the trajectories are not correct to the user interface, the acquisition unit 21 acquires an instruction indicating that the trajectories to be integrated by the trajectory integration unit 22 are not correct. In this case, the output unit 24 outputs a user interface for accepting an instruction as to which trajectory among one or a plurality of trajectories is the same.

With this configuration, the trajectory integration unit 22 can increase the reliability of the integrated trajectory.

### Flow of Information Processing Method S2

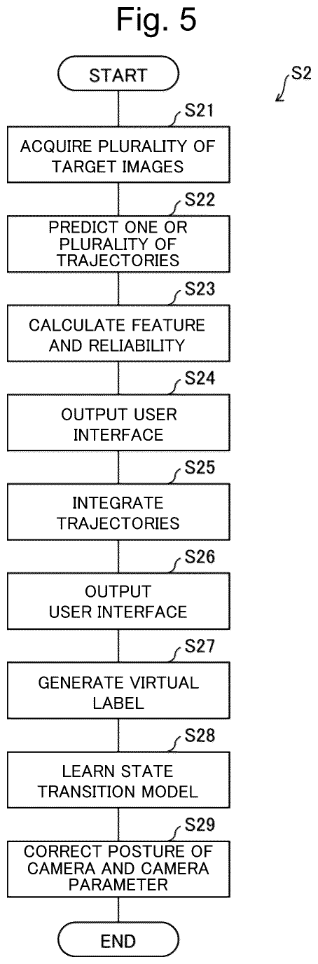

A flow of an information processing method S2 executed by the information processing device 2 will be described with reference to FIG. 5. FIG. 5 is a flowchart illustrating the flow of the information processing method S2.

### Step S21

In step S21, the acquisition unit 21 acquires a plurality of target images TP. The acquisition unit 21 stores the plurality of acquired target images TP in the storage unit 30.

### Step S22

In step S22, the trajectory prediction unit 11 predicts the trajectory of the object included in at least one of the plurality of target images TP with reference to the plurality of target images TP. The trajectory prediction unit 11 supplies trajectory information indicating the predicted one or a plurality of trajectories to the calculation unit 12 and the trajectory integration unit 22.

### Step S23

In step S23, the calculation unit 12 extracts a feature of each of the one or a plurality of trajectories predicted by the trajectory prediction unit 11, and calculates a reliability of each of the one or a plurality of trajectories based on the feature. The calculation unit 12 supplies the extracted feature and the calculated reliability to the trajectory integration unit 22 and the virtual label generation unit 13.

### Step S24

In step S24, the output unit 24 outputs a user interface for accepting an instruction for one or a plurality of trajectories supplied from the trajectory prediction unit 11.

### Step S25

In step S25, the trajectory integration unit 22 integrates trajectories having similar features and high reliabilities among one or a plurality of trajectories. The trajectory integration unit 22 supplies the integrated trajectory to the virtual label generation unit 13.

In a case where the acquisition unit 21 acquires the user's instruction for the user interface output by the output unit 24 in step S24, the trajectory integration unit 22 integrates the trajectories based on the instruction.

### Step S26

In step S26, the output unit 24 outputs a user interface for accepting an instruction for the virtual label VL.

### Step S27

In step S27, the virtual label generation unit 13 generates a virtual label VL for learning the state transition model, in which each of the plurality of target images TP, the position of the object included in the target image TP detected by the object detection unit 111, the trajectory integrated by the trajectory integration unit 22, and the reliability calculated by the calculation unit 12 are associated with each other. The virtual label generation unit 13 stores the generated virtual label VL in the storage unit 30.

In a case where the acquisition unit 21 acquires a user's instruction for the user interface output by the output unit 24 in step S26, the virtual label generation unit 13 changes the virtual label VL based on the instruction.

### Step S28

In step S28, the learning unit 14 learns at least one of the first prediction model PM1 and the second prediction model PM2 lighter than the first prediction model PMI using the virtual label VL.

In a case where the learning unit 14 has learned the first prediction model PM1, the information processing device 2 can generate the virtual label VL with a higher reliability by repeatedly executing steps S22 to S29 using the plurality of target images TP acquired in step S21. Since the learning unit 14 learns the first prediction model PMI using the virtual label VL with a higher reliability, it is possible to generate the first prediction model PM1 with high accuracy.

In a case where the learning unit 14 learns (knowledge distillation) the second prediction model PM2, it is possible to generate the second prediction model PM2 that is lighter than the first prediction model PM1 and moves at a high speed. For example, the learning unit 14 can generate a state transition model used in an edge.

### Step S29

In step S29, the camera calibration unit 23 calibrates the postures and the camera parameters of the plurality of cameras using the virtual label VL.

### Effects of Information Processing Device 2

As described above, in the information processing device 2, one or a plurality of trajectories of the object included in the plurality of target images TP are predicted, the reliability is calculated based on the feature of each of the one or plurality of trajectories, the trajectories having similar features and high reliabilities are integrated, and the virtual label VL in which the target image TP, the position of the object included in the target image, the integrated trajectory, and the reliability are associated with each other is generated.

Therefore, the information processing device 2 can generate a large number of pieces of training data for learning a machine learning model for predicting the trajectory of the object. Therefore, the information processing device 2 can compensate for the shortage of the training data for learning the machine learning model for predicting the trajectory of the object.

### Example of Implementation by Software

Some or all of the functions of the information processing devices 1 and 2 (hereinafter, also referred to as “each of the above devices”) may be implemented by hardware such as an integrated circuit (an IC chip) or may be implemented by software.

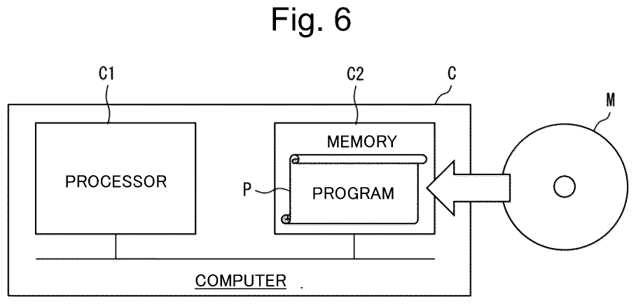

In the latter case, each of the above devices is implemented by, for example, a computer that executes a command of a program which is software for implementing each function. An example of such a computer (hereinafter, referred to as a computer C) is illustrated in FIG. 6. FIG. 6 is a block diagram illustrating a hardware configuration of the computer C functioning as each of the above devices.

The computer C includes at least one processor C1 and at least one memory C2. A program P for causing the computer C to operate as each of the above devices is recorded in the memory C2. In the computer C, the processor C1 reads the program P from the memory C2 and executes the program P to implement each function of each of the above devices.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

In order to create training data for learning a machine learning model for predicting a trajectory of an object, it is necessary to associate the same object in each of a plurality of images. Since such association work is required, there is a problem that the number of pieces of training data is insufficient.

The present disclosure has been made in view of the above problems, and an exemplary object thereof is to provide a technique or the like for compensating for a shortage of training data for learning a machine learning model for predicting a trajectory of an object.

### SUPPLEMENTARY NOTES

The present disclosure includes the technologies described in the following supplementary notes. However, the present disclosure is not limited to the techniques described in the following supplementary notes, and various modifications can be made within the scope described in the claims.

### Supplementary Note 1

An information processing device including:
a trajectory prediction means for predicting a trajectory of an object included in at least one of a plurality of target images with reference to the plurality of target images;
a calculation means for extracting a feature of the trajectory and calculating a reliability of the trajectory based on the feature;
a virtual label generation means for generating a virtual label in which each of the plurality of target images, a position of the object included in the target image, the trajectory, and the reliability are associated with each other; and
a learning means for learning a state transition model that predicts a state of an object included in a plurality of images by using the virtual label.

### Supplementary Note 2

The information processing device according to Supplementary Note 1, further including
a trajectory integration means for integrating a plurality of trajectories, in which
the trajectory prediction means predicts one or a plurality of trajectories of an object included in at least one of a plurality of target images with reference to the plurality of target images,
the calculation means extracts a feature of each of the one or a plurality of trajectories and calculates a reliability of each of the one or a plurality of trajectories based on the feature,
the trajectory integration means integrates trajectories having similar features and high reliabilities among the one or a plurality of trajectories, and
the virtual label generation means generates a virtual label in which each of the plurality of target images, a position of the object included in the target image, the integrated trajectory, and the reliability are associated with each other.

### Supplementary Note 3

The information processing device according to Supplementary Note 1 or 2, in which the trajectory prediction means predicts a trajectory of an object included in at least one of a plurality of target images by inputting the plurality of target images to a prediction model that predicts a trajectory of an object included in a plurality of images using the plurality of images as inputs.

### Supplementary Note 4

The information processing device according to Supplementary Note 3, in which the learning means learns the prediction model using the virtual label.

### Supplementary Note 5

The information processing device according to Supplementary Note 3 or 4, in which the learning means performs knowledge distillation of a state transition model lighter than the prediction model by using the virtual label.

### Supplementary Note 6

The information processing device according to Supplementary Note 2, in which the trajectory integration means acquires information regarding the object detected by a sensor, and further refers to the information to integrate trajectories.

### Supplementary Note 7

The information processing device according to any one of Supplementary Notes 1 to 6, in which
the plurality of target images are images captured by a plurality of cameras that capture the object from different positions, and
the information processing device further comprises a camera calibration means for calibrating postures and camera parameters of the plurality of cameras using the virtual label.

### Supplementary Note 8

The information processing device according to Supplementary Note 7, in which the plurality of cameras include a camera that captures the object from above.

### Supplementary Note 9

An information processing method for causing at least one processor to execute:
a process of predicting a trajectory of an object included in at least one of a plurality of target images with reference to a plurality of target images;
a process of extracting a feature of the trajectory and calculating a reliability of the trajectory based on the feature;
a process of generating a virtual label in which each of the plurality of target images, a position of the object included in the target image, the trajectory, and the reliability are associated with each other; and
a process of learning a state transition model that predicts a state of an object included in a plurality of images by using the virtual label.

### Supplementary Note 10

An information processing program for causing a computer to function as an information processing device including:
a trajectory prediction means for predicting a trajectory of an object included in at least one of a plurality of target images with reference to a plurality of target images;
a calculation means for extracting a feature of the trajectory and calculating a reliability of the trajectory based on the feature;
a virtual label generation means for generating a virtual label in which each of the plurality of target images, a position of the object included in the target image, the trajectory, and the reliability are associated with each other; and
a learning means for learning a state transition model that predicts a state of an object included in a plurality of images by using the virtual label.

### Supplementary Note 11

The information processing device according to any one of Supplementary Notes 1 to 8, in which the learning means adopts the virtual label as important training data as the reliability associated with the virtual label is higher.

### Supplementary Note 12

The information processing device according to any one of Supplementary Notes 1 to 8, and 11, further including:
an output means for outputting a user interface configured to accept an instruction for the virtual label; and
an acquisition means for acquiring an instruction for the user interface,
in which the virtual label generation means generates the virtual label based on the instruction.

### Supplementary Note 13

The information processing device according to Supplementary Note 2, further including:
an output means for outputting a user interface configured to accept an instruction for the one or a plurality of trajectories; and
an acquisition means for acquiring an instruction for the user interface,
in which the trajectory integration means integrates trajectories based on the instruction.

1. An information processing device comprising:
a memory configured to store instructions; and
one or more processors configured to execute the instructions to:
predict a trajectory of an object included in at least one of a plurality of target images with reference to the plurality of target images;
extract a feature of the trajectory;
calculate a reliability of the trajectory based on the feature;
generate a virtual label in which each of the plurality of target images, a position of the object included in the target image, the trajectory, and the reliability are associated with each other; and
learn a state transition model that predicts a state of an object included in a plurality of images by using the virtual label.

2. The information processing device according to claim 1, wherein the one or more processors are further configured to execute the instructions to:
integrate a plurality of trajectories;
predict one or a plurality of trajectories of an object included in at least one of a plurality of target images with reference to the plurality of target images;
extract a feature of each of the one or a plurality of trajectories;
calculate a reliability of each of the one or a plurality of trajectories based on the feature;
integrate trajectories having similar features and high reliabilities among the one or a plurality of trajectories; and
generate a virtual label in which each of the plurality of target images, a position of the object included in the target image, the integrated trajectory, and the reliability are associated with each other.

3. The information processing device according to claim 1, wherein
the one or more processors are further configured to execute the instructions to:
predict a trajectory of an object included in at least one of a plurality of target images by inputting the plurality of target images to a prediction model that predicts a trajectory of an object included in a plurality of images using the plurality of images as inputs.

4. The information processing device according to claim 3, wherein
the one or more processors are further configured to execute the instructions to:
learn the prediction model using the virtual label.

5. The information processing device according to claim 3, wherein
the one or more processors are further configured to execute the instructions to:
perform knowledge distillation of a state transition model lighter than the prediction model by using the virtual label.

6. The information processing device according to claim 2, wherein
the one or more processors are further configured to execute the instructions to:
acquire information regarding the object detected by a sensor; and
refer to the information to integrate trajectories.

7. The information processing device according to claim 1, wherein
the plurality of target images are images captured by a plurality of cameras that capture the object from different positions, and
the one or more processors are further configured to execute the instructions to:
calibrate postures and camera parameters of the plurality of cameras using the virtual label.

8. The information processing device according to claim 7, wherein
the plurality of cameras include a camera that captures the object from above.

9. An information processing method comprising:
predicting a trajectory of an object included in at least one of a plurality of target images with reference to the plurality of target images;
extracting a feature of the trajectory;
calculating a reliability of the trajectory based on the feature;
generating a virtual label in which each of the plurality of target images, a position of the object included in the target image, the trajectory, and the reliability are associated with each other; and
learning a state transition model that predicts a state of an object included in a plurality of images by using the virtual label.

10. A non-transitory computer-readable recording medium storing a program for causing a computer to execute the steps of:
predicting a trajectory of an object included in at least one of a plurality of target images with reference to the plurality of target images;
extracting a feature of the trajectory;
calculating a reliability of the trajectory based on the feature;
generating a virtual label in which each of the plurality of target images, a position of the object included in the target image, the trajectory, and the reliability are associated with each other; and
learning a state transition model that predicts a state of an object included in a plurality of images by using the virtual label.
